(19) United States
(12) Patent Application Publication
(10) Pub. No.: US 2025/0208255 A1
(43) Pub. Date: Jun. 26, 2025

(54) RANGE PROCESSING USING FAST-FOURIER TRANSFORMATION COMPUTATIONS

(71) Applicant: TEXAS INSTRUMENTS INCORPORATED, Dallas, TX (US)

(72) Inventors: Sandeep Rao, Bangalore (IN); Karthik Subburaj, Bangalore (IN)

(21) Appl. No.: 18/617,197

(22) Filed: Mar. 26, 2024

(30) Foreign Application Priority Data
Dec. 21, 2023 (IN) 202341087633

(51) Int. Cl. G01S 7/288; G01S 13/18

(52) U.S. Cl. CPC G01S 7/2883; G01S 13/18

(57) ABSTRACT

Various examples disclosed herein relate to digital signal processing, and particularly, to processing range data using Fast-Fourier Transform (FFT) operations. In an example, a system includes transceiver circuitry and processing circuitry coupled to the transceiver circuitry. The transceiver circuitry is configured to receive signals reflected off an object and generate radar data based on the signals. The processing circuitry is configured to perform a first FFT operation on the radar data to produce a first set of range data, perform a frequency shift on the radar data, perform a second FFT operation on the frequency shifted radar data to produce a second set of range data, and produce a third set of range data by collating the first set of range data and a portion of the second set of range data or collating a portion of the first set of range data and the second set of range data.

### CROSS-REFERENCE TO RELATED APPLICATIONS

This application claims the priority benefit of India Provisional Patent Application No. 202341087633, filed Dec. 21, 2023, entitled “MITIGATING SCALLOPING LOSS WITH MINIMUM MEMORY OVERHEAD,” which is hereby incorporated herein by reference.

### TECHNICAL FIELD

This disclosure relates generally to processing digital signals using Fast-Fourier Transform operations.

### BACKGROUND

In radar applications, various digital signal processing techniques may be employed to detect nearby objects and characteristics thereof. For example, various systems may detect objects and their positions and distances relative to a system by using one or more algorithms, such as range Fast-Fourier Transform (FFT) algorithms, doppler processing, and range processing, among other techniques, on radio frequency signals transmitted towards the objects and received from the objects in return.

In operation, existing solutions that employ one or more of these algorithms may detect false objects, or incorrectly identify relative distance between an object and a system. To reduce false alarm rates, noise, and issues caused thereby, some solutions perform such algorithms using higher resolution detection grids. However, doing so increases compute power requirements and memory requirements, which may not only add costs to the design of a system, but also increase compute time during operation of object detection processes.

### SUMMARY

Disclosed herein are improvements to processing of digital signals to detect ranges of objects, such as via range, doppler, and angle processing techniques. More specifically, improvements described herein relate to processing signals using one or more Fast-Fourier Transform (FFT) operations and collating data across the one or more FFT operations to mitigate scalloping loss and increase memory usage efficiency. In an example embodiment, a system includes transceiver circuitry and processing circuitry coupled to the transceiver circuitry. The transceiver circuitry is configured to receive signals reflected off an object and generate radar data. The processing circuitry is configured to perform a first FFT operation on the radar data to produce a first set of range data, perform a frequency shift on the radar data, perform a second FFT operation on the frequency shifted radar data to produce a second set of range data, and produce a third set of range data by at least collating the first set of range data and a portion of the second set of range data or collating a portion of the first set of range data and the second set of range data.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment configurable to process range data in an implementation.

FIG. 2 illustrates an example aspect of processing range data in an implementation.

FIGS. 3A and 3B illustrate series of steps for processing range data in an implementation.

FIG. 4 illustrates an example flow chart related to processing range data in an implementation.

FIG. 5 illustrates example aspects of detection ranges associated with range data in an implementation.

FIG. 6 illustrates graphical representations showing range data and an associated threshold in an implementation.

FIGS. 7A and 7B illustrate example block diagrams related to processing range data in an implementation.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

Embodiments of the present disclosure are described in specific contexts, such as detecting distances and orientations of objects relative to one or more transceivers or antennas by processing radar data. Some embodiments may be used with other types of data. Some embodiments may use other types of processing operations, processing techniques, or processing devices and circuitry that lead to improved memory usage efficiency and reduced scalloping loss, among other benefits.

Discussed herein are enhanced components, techniques, systems, and methods related to processing data corresponding to objects and distances, orientations, angles, and positions of the objects. In various example implementations, one or more antennas may be used to transmit signals (also referred to as chirps) and receive signals reflected off an object or a target. The received signals can be used to create intermediate frequency (IF) signals and digitized (i.e., using an analog-to-digital converter (ADC)) to create ADC samples. Operations, such as Fast-Fourier Transforms (FFTs), can be performed on the ADC samples to detect characteristics of the object, such as the distance of the object relative to the antennas, the angle of the object relative to the antennas, and the like. Results of such operations may indicate varying levels of signal power, which may be indicative of distance between the antennas and the object.

Some systems may be employed to detect many objects of different sizes and from varying distances with high accuracy for safety reasons, for example. To improve detection capabilities and range detection accuracy, existing solutions may perform FFT operations using high-resolution grids. However, increasing grid resolution of FFT operations entails higher compute cost, which requires additional compute time and power. Additionally, performing operations using fine grids also increases storage capacity requirements and/or through-put requirements, which also leads to additional time and power and reduced available memory for other activities.

Instead, as disclosed herein, systems, devices, and methods for performing range data processing can use high-resolution FFTs to improve signal-to-noise ratio (SNR) of an FFT to increase detection range and accuracy and data selection techniques therewith to reduce proportional memory usage. For example, multiple FFTs can be performed on data using a grid of a certain resolution, and data points can be selected and collated among the FFTs to produce a set of data that can be stored and used for further processing to detect characteristics of an object. The set of collated data can include data within thresholds such that memory requirements is decreased relative to an amount of memory required to store all data from the multiple FFTs. As a technical effect, range detection accuracy and efficiency may be improved (e.g., fewer false/inaccurate detections) without increasing power, data through-put, and memory requirements.

One example embodiment, a system includes transceiver circuitry and processing circuitry coupled to the transceiver circuitry. The transceiver circuitry is configured to obtain radar signals reflected off an object and generate digital values based on the signals for use by the processing circuitry. The processing circuitry is configured to perform a first FFT operation on the radar data to produce a first set of range data, perform a frequency shift on the radar data, perform a second FFT operation on the frequency shifted radar data to produce a second set of range data, and produce a third set of range data by at least collating the first set of range data and a portion of the second set of range data or collating a portion of the first set of range data and the second set of range data.

In another example embodiment, a method of producing sets of range data is provided. The method includes obtaining radar data generated by radar transceiver circuitry, performing a first FFT operation on the radar data to produce a first set of range data, performing a frequency shift on the radar data, performing a second FFT operation on the frequency shifted radar data to produce a second set of range data, and producing a third set of range data by at least collating the first set of range data and a portion of the second set of range data, or collating a portion of the first set of range data and the second set of range data.

In yet another embodiment, a radar circuit including a buffer and a processor coupled to the buffer and configured to obtain radar data stored in the buffer, perform a first FFT operation on the radar data to produce a first set of range data, perform a frequency shift on the radar data, perform a second FFT operation on the frequency shifted radar data to produce a second set of range data, and produce a third set of range data for storage in the buffer by at least collating the first set of range data and a portion of the second set of range data, or collating a portion of the first set of range data and the second set of range data.

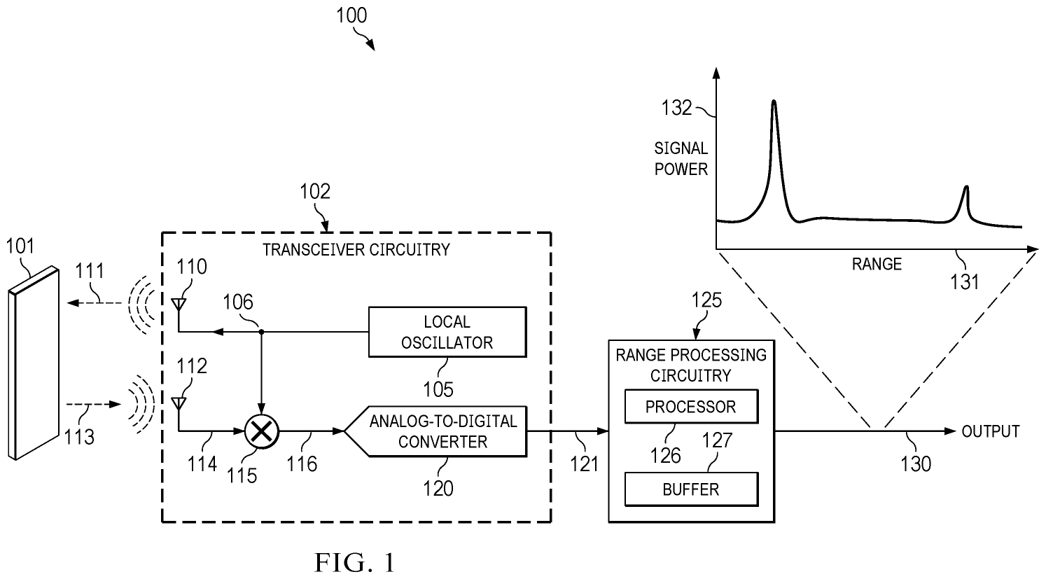

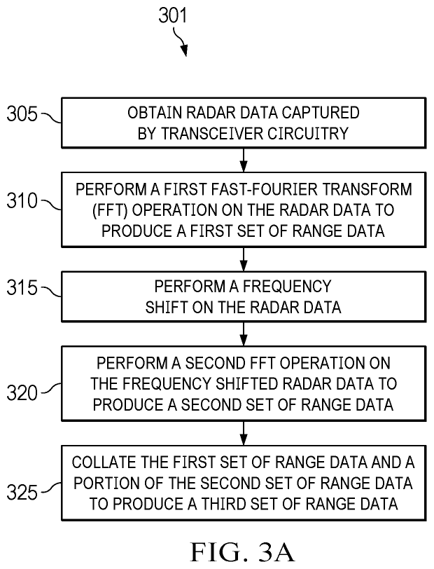

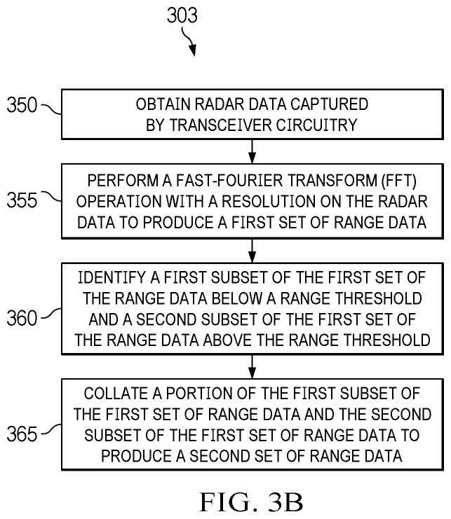

FIG. 1 illustrates an example operating environment configurable to process range data in an implementation. FIG. 1 shows operating environment 100, which includes object 101, transceiver circuitry 102, and range processing circuitry 125. Transceiver circuitry 102 includes local oscillator 105, antenna 110, antenna 112, mixer 115, and analog-to-digital converter (ADC) 120. Range processing circuitry 125 includes processor 126 and buffer 127. In various examples, range processing circuitry 125 may be configured to operate range processing operations, such as processes 301 and 303 of FIGS. 3A and 3B, respectively.

In various embodiments, transceiver circuitry 102 may be representative of a system, subsystem, device, or one or more circuits capable of transmitting and receiving radar signals to be processed using digital signal processing techniques for object detection, object range detection, and object characteristic analysis, among other purposes, such as by range processing circuitry 125. In an example, transceiver circuitry 102 may be included in an object detection and/or range detection system, such as in a vehicle. As shown in operating environment 100, transceiver circuitry 102 includes local oscillator 105, antenna 110, antenna 112, mixer 115, and ADC 120. The transmit and receive chains of transceiver circuitry 102 may include additional components not shown in FIG. 1, such as amplifiers, filters, splitters, and/or combiners.

Local oscillator 105 may be representative of a signal generation circuit that includes one or more oscillators configured to generate a local oscillator (LO) signal 106. In various examples, local oscillator 105 may be configured to produce LO signal 106 that includes a series of pulses that sweep through a frequency range (i.e., from a minimum frequency to a maximum frequency) and that are evenly distributed throughout a period of time. In other words, LO signal 106 may be transmitted, such as via antenna 110, as a series of equidistant chirps 111. Local oscillator 105 is coupled to antenna 110 and to mixer 115 and can provide LO signal 106 to antenna 110 and mixer 115.

Antennas 110 and 112 may be representative of one or more antennas capable of transmitting and receiving signals, respectively, from one or more devices or objects. Antenna 110 may be coupled to local oscillator 105 and may be configured to receive LO signal 106 from local oscillator 105. Based on LO signal 106, antenna 110 may be configured to transmit chirps 111 (i.e., a pattern of radio frequency (RF) signal pulses)) towards object 101. Object 101 may be an object, a device, a person, a landscape, a building or structure, or the like, that includes various properties or characteristics. Antenna 110 can transmit chirps 111 at or towards object 101, and chirps 113 may reflect off object 101 and scatter back to antenna 112. Antenna 112 may be configured to receive chirps 113 that reflect from object 101 and may be coupled to provide signals 114, based on chirps 113, to mixer 115. Additional example details of radar chirps can be found in commonly assigned U.S. Pat. No. 11,378,649, entitled “Methods and Apparatus for Velocity Detection in MIMO Radar Including Velocity Ambiguity Resolution,” filed Mar. 10, 2020, and U.S. Patent Application Publication No. 2022/0308196, entitled “Method and Apparatus for Low Power Motion Detection,” filed Jul. 29, 2021, which is incorporated by reference in its entirety.

Mixer 115 may be representative of a device or circuit configured to mix, convert, or down-convert LO signal 106 and signals 114 to produce intermediate frequency (IF) signals 116. Mixer 115 may be coupled to ADC 120 and can provide IF signals 116 to ADC 120. For example, IF signals 116 may include each emitted chirp by antenna 110 (chirps 111) and its corresponding reflected chirp(s) received by antenna 112 (chirps 113). ADC 120 can convert IF signals 116 to digital signals 121 (e.g., digital values/numbers) and provide digital signals 121 to range processing circuitry 125. In some examples, ADC 120 may be a separate component that is outside of transceiver circuitry 102. Operating environment 100 may include multiple ADCs 120 coupled to range processing circuitry 125.

While only two antennas are shown in operating environment 100, additional or fewer antennas may be included in a system and can produce various chirps and signals across several frequencies and/or distributed differently across a time period, which can be mixed by mixer 115, converted by ADC 120, and processed by range processing circuitry 125. Additionally, transceiver circuitry 102 may include additional components (e.g., amplifiers, filters, etc.) or fewer components such that transceiver circuitry 102 may output digital signals 121 to range processing circuitry 125 without mixing the signals into IF signals 116, for example.

Range processing circuitry 125 may be representative of a system, device, or one or more circuits (e.g., a hardware accelerator) configured to receive digital signals 121, perform digital signal processing operations on digital signals 121, and produce output 130 that may include one or more sets of data that can be used to detect distance between object 101 and transceiver circuitry 102, among other parameters. In various examples, range processing circuitry 125 includes processor 126 and buffer 127.

Processor 126 may be representative of one or more processors, processing circuits, and/or processing units configured to perform range processing operations (e.g., FFT operations), among other operations, on digital signals 121. Examples of processor 126 may include a central processing units (CPU), a general purpose processing unit, a digital signal processor (DSP), an application specific integrated circuit (ASIC), a field-programmable gate array (FPGA), a hardware accelerator, and/or the like, including combinations or variations thereof. In some examples, processor 126 may include multiple components, such as any combination of the processing resources listed above, as well as other discrete or integrated logic circuitry, and/or analog circuitry. As processor 126 processes digital signals 121, processor 126 may store data in buffer 127.

Buffer 127 may be representative of one or more computer-readable, non-transitory storage media capable of storing digital signals 121, output 130, and other data and/or instructions. Example non-transitory computer-readable storage media may include random access memory (RAM), read-only memory (ROM), programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can change over time (e.g., in RAM or cache).

In a first example, processor 126 may be configured to perform a first FFT operation on digital signals 121 to produce a first set of range data corresponding to a set of chirp(s). Processor 126 may perform the first FFT operation using a grid of a certain resolution (e.g., fine or coarse grid). In some examples, a fine resolution is used by performing a zero-padded FFT. Then, processor 126 can perform a frequency shift on the digital signals 121 to produce a frequency-shifted set of range data. In various implementations, the frequency shift may include a shift of half a range-bin, however, shifts of other values (e.g., one-third of a range-bin) may be implemented. Processor 126 can perform a second FFT operation on the frequency-shifted set of range data to produce a second set of range data. In some implementations, the resolutions of the grids may be the same or may differ between the first and second FFT operations.

Next, processor 126 produces output 130, or a third set of range data, by collating the first set of range data and a portion of the second set of range data or by collating a portion of the first set of range data and the second set of range data. In this way, output 130 includes fewer than all of the data points produced by performing the first and second FFT operations. In various implementations, processor 126 may select the data points within either the first or second sets of range data to be collated together based on one or more thresholds, such as a range threshold. For example, processor 126 may refrain from collating data of the first or the second sets of range data that falls below the range threshold. In other words, processor 126 might discard or not store such data in buffer 127 or provide such data downstream in output 130. As a result, the density of data points stored in buffer 127 may be higher at longer ranges (e.g., beyond the range threshold) than the density of data points stored in buffer 127 at shorter ranges (e.g., inside the range threshold).

In a second example, processor 126 performs an FFT operation on digital signals 121 using a resolution (e.g., a fine grid, a coarse grid) to produce a first set of range data. Processor 126 identifies a first subset of the set of range data below the range threshold and a second subset of the set of range data exceeding the range threshold. Then, processor 126 produces a second set of range data using a portion of the first subset of the set of range data and the second subset of the set of range data. In this way, processor 126 may refrain from using or storing some of the data below the range threshold that might not be necessary to detect a distance between object 101 and transceiver circuitry 102, and thus, processor 126 may conserve memory capacity.

During or after processor 126 performing each FFT operation in each of the examples above, processor 126 can store the sets of range data, or portions thereof, in buffer 127. Processor 126 provides output 130 (i.e., the third set of range data) to one or more downstream systems or devices for further use or processing. Output 130 includes range data with respect to range 131 and signal power 132. Range processing circuitry 125, or another system, device, or circuit, may use output 130 to detect a distance between object 101 and transceiver circuitry 102. For example, data having high signal power 132 across range 131 may indicate a distance value.

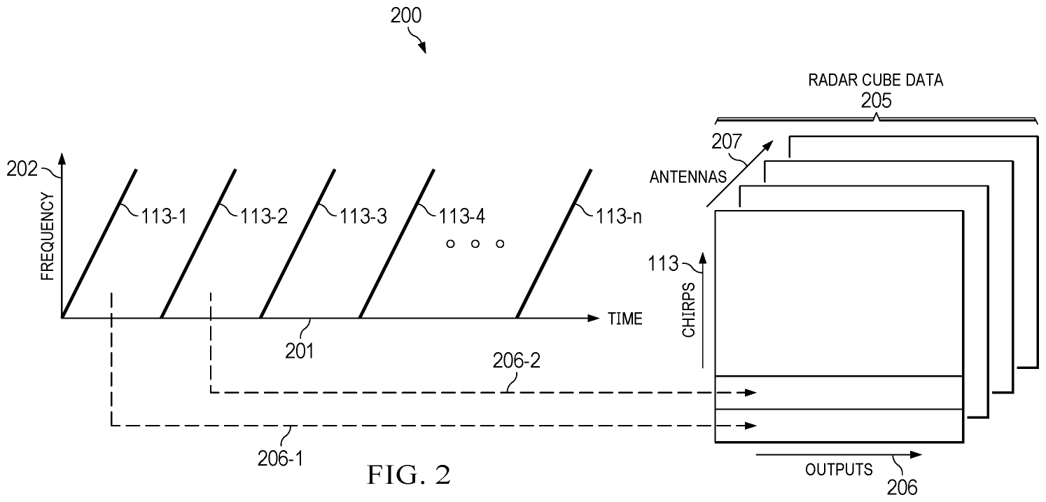

FIG. 2 illustrates an example aspect of processing range data in an implementation. FIG. 2 shows aspect 200, which includes multiple graphical representations corresponding to chirp data and processing thereof, which references elements of FIG. 1. Aspect 200 includes a first graphical representation of chirps with respect to time 201 and frequency 202 and a second graphical representation of radar cube data 205 that includes outputs 206 across chirps 113 corresponding to antennas 207.

In aspect 200, the first graphical representation shows a series of chirps 113 distributed evenly over time 201 in a scan frame transmitted and received by a transceiver (e.g., transceiver circuitry 102 of FIG. 1) via antennas (e.g., antennas 110 and 112 of FIG. 1) towards an object (e.g., object 101 of FIG. 1). For example, a transmitter may transmit a number of chirps of the same or varying frequencies that sweeps through a chirp bandwidth to generate a radar cube represented by radar cube data 205. In some implementations, a transceiver may include multiple antennas that can each transmit and receive chirps. In this example, a transceiver may transmit and receive n number of successive chirps 113 separated in the time domain (time 201) by a chirp duration. Each chirp may represent the duration in which a local oscillator coupled to the antenna (e.g., local oscillator 105) ramps the frequency 202 of each chirp across the chirp bandwidth for transmission.

Also shown in aspect 200, the second graphical representation shows radar cube data 205. Radar cube data 205 includes results in the form of a chart, a table, a graph, a matrix, that includes outputs 206 across chirps 113 for each of antennas 207 in a system. Outputs 206 may represent data produced by performing range FFT operations on chirps 113, such as via a range detection circuit (e.g., range processing circuitry 125 of FIG. 1). Specifically, output 206-1 may be produced using chirp 113-1, output 206-2 may be produced using chirp 113-2, and so on. Additional outputs 206 may also be produced using chirps from other antennas 207 and may be included in radar cube data 205. In various examples, radar cube data 205 may be stored in a memory (e.g., buffer 127 of FIG. 1).

FIGS. 3A and 3B illustrate series of steps for processing range data in an implementation. FIG. 3A includes process 301 and FIG. 3B includes process 303, each of which reference elements of FIG. 1. Processes 301 and 303 may be implemented on software, firmware, or hardware, or combinations or variations thereof. For example, processes 301 and 303 may be performed by range processing circuitry in a digital signal processing system, such as processor 126 of range processing circuitry 125 of FIG. 1.

Referring first to process 301 of FIG. 3A, in operation 305, range processing circuitry 125 obtains digital signals 121 (e.g., radar data) captured by transceiver circuitry 102. In various examples, transceiver circuitry 102 produces digital signals 121 by transmitting, via antenna 110, a series of chirps 111 based on LO signal 106 provided to antenna 110 by local oscillator 105 towards object 101, receiving, via antenna 112, a series of chirps 113 reflected off object 101, mixing LO signal 106 with the received signals 114 into IF signals 116, and converting, via ADC 120, IF signals 116 to digital signals 121. LO signal 106 may include a series of pulses that sweep through a frequency range (i.e., from a minimum frequency to a maximum frequency) and that are evenly distributed throughout a period of time. Antenna 110 transmits these pulses, or chirps 111, towards object 101, which may be reflected off object 101 and received as return pulses, or chirps 113. Accordingly, digital signals 121 may include radar signals based on chirps 111 and 113.

In operation 310, radar detection circuitry 125 performs a first FFT operation on digital signals 121 to produce a first set of range data that corresponds to chirps 111 and 113. Radar detection circuitry 125 may perform the first FFT operation using a grid of a certain resolution (e.g., a fine resolution, a course resolution). In an example, this may include performing a non-zero padded range FFT operation. In some embodiments a zero-padded FFT might be performed to increase the resolution of the computed FFT. The first set of range data may include a number of data points with respect to range 131 and signal power 132.

In operation 315, range processing circuitry 125 performs a frequency shift on digital signals 121 to produce a frequency-shifted set of range data. In various examples, range processing circuitry 125 may shift the frequency of the first set of range data by half of a range-bin. Here, range bin refers to the range difference corresponding to adjacent outputs of the range-FFT (alternatively can be viewed as the resolution of the grid). In an N-point FFT, the spacing between range bins is 2π/N. As such, a frequency shift of half a range-bin may be equivalent to multiplying the k^{th} sample in the digital signal 121 by e^{-jωk}, where

$$k = \frac{π}{N} .$$

In other examples, range processing circuitry 125 may perform a frequency shift of a different range-bin value.

Next, in operation 320, range processing circuitry 125 performs a second FFT operation on the frequency-shifted set of range data to produce a second set of range data. In this example, range processing circuitry 125 performs the second FFT operation using a grid of a certain resolution. The resolutions of the grids with respect to the first FFT operation and the second FFT operation may be the same. However, range processing circuitry 125 may use different resolution grids for each or both of the FFT operations. Like the first FFT operation, range processing circuitry 125 may produce the second set of range data that may include a number of data points with respect to range 131 and signal power 132, however, the data points may be shifted with respect to range 131 relative to the data points of the first set of range data.

In operation 325, range processing circuitry 125 collates portions of the sets of range data together to produce a third set of range data, which range processing circuitry 125 may provide downstream as output 130. In an example, range processing circuitry 125 collates all of the data points of the first set of range data with a portion of the data points of the second set of range data. In another example, range processing circuitry 125 collates a portion of the data points of the first set of range data with all of the data points of the second set of range data. In this way, output 130 includes fewer than all of the data points produced by performing the first and second FFT operations. Range processing circuitry 125 may select the data points within either the first or second sets of range data to be collated together based on one or more thresholds, such as a range threshold. For example, range processing circuitry 125 may refrain from collating data of the first or the second sets of range data that falls below the range threshold. In other words, if range processing circuitry 125 chooses not to collate some of either the first or second set of range data, range processing circuitry 125 might discard or not store such data in buffer 127 or not provide such data downstream in output 130. In effect, range processing circuitry 125 may reduce memory capacity requirements to store output 130 without reducing the efficacy of output 130 with respect to detecting distances and positions of object 101, among other objects, relative to transceiver circuitry 102.

Referring next to process 303 of FIG. 3B, in operation 350, range processing circuitry 125 obtains digital signals 121 captured by transceiver circuitry 102 (i.e., by processes described above in operations 305 and 310, for example, of process 301). In operation 355, range processing circuitry 125 performs an FFT operation with a resolution on digital signals 121 to produce a first set of range data. In this example, range processing circuitry 125 may use a high-resolution for the FFT operation to produce a fine grid output. The high resolution is achieved by performing a zero-padded FFT (i.e., zero-padding prior to performing the FFT operation).

In operation 360, range processing circuitry 125 identifies a first subset of the range data below a range threshold and a second subset of the range data exceeding the range threshold. The range data below the range threshold may include data corresponding to signals reflected back to transceiver circuitry 102 from objects that are closer to transceiver circuitry 102 than the range threshold. Likewise, the range data that exceeds the range threshold may include data corresponding to signals reflected back to transceiver circuitry 102 from objects that are farther from transceiver circuitry 102 than the range threshold. In operation 365, range processing circuitry 125 collates a portion of the first subset of the first set of range data and the second set of range data to produce a second set of range data. More specifically, in some embodiments, a direct memory access (DMA) controller coupled to range processing circuitry 125 may write the first subset and the second subset to a memory to generate a single set (the second set) of range data. In some of such embodiments, range processing circuitry 125 can perform one or more FFT operations on digital signals 121 and perform a pruning operation in-situ (i.e., determine which data points to store prior to the DMA controller writing subsets to memory). In various examples, the portion of the first subset of the range data includes less than all of the data points in the first subset of the range data. Accordingly, range processing circuitry 125 may discard or refrain from storing some of the first subset of the range data when producing the second set of range data. In effect, range processing circuitry 125 may reduce memory capacity requirements to store output 130 without reducing the efficacy of output 130 with respect to detecting distances and positions of object 101, among other objects, relative to transceiver circuitry 102.

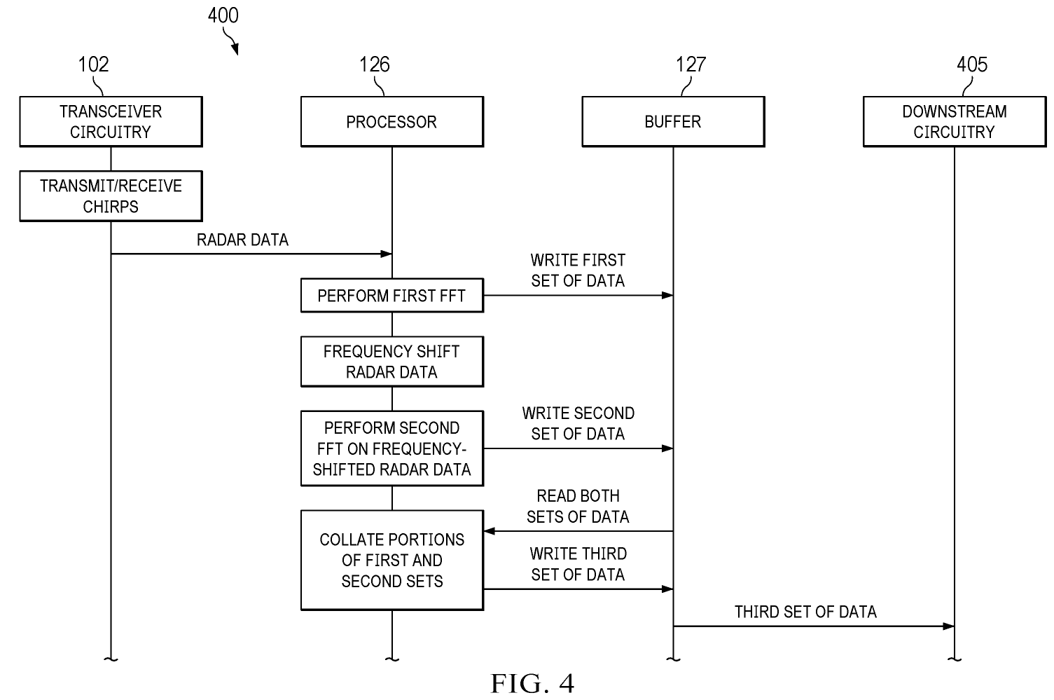

FIG. 4 illustrates an example flow chart related to processing range data in an implementation. FIG. 4 shows environment 400, which references elements of FIG. 1, and as such, includes transceiver circuitry 102, processor 126, buffer 127, and downstream circuitry 405.

Environment 400 may be representative of a system capable of obtaining radar data, performing range processing operations and other digital signal processing operations on the radar data, and identifying properties and positions of objects relative to the system based on the processed radar data. For example, elements of environment 400 may be used in the context of a self-driving vehicle. These elements may be used to detect objects around the vehicle and relative proximity of the objects to the vehicle during operation of the vehicle to ensure safe operation. Other contexts may also be contemplated.

In operation, transceiver circuitry 102 produces radar data by transmitting, via antenna 110, a series of chirps 111 based on LO signal 106 provided to antenna 110 by local oscillator 105 towards object 101, receiving, via antenna 112, a series of chirps 113 reflected off object 101, mixing LO signal 106 with the received signals 114 into IF signals 116, and converting, via ADC 120, IF signals 116 to digital signals 121. LO signal 106 may include a series of pulses that sweep through a frequency range (i.e., from a minimum frequency to a maximum frequency) and that are evenly distributed throughout a period of time. Antenna 110 transmits these pulses, or chirps 111, towards object 101, which may be reflected off object 101 and received as return pulses, or chirps 113. Transceiver circuitry 102 provides the radar data, based on chirps 111 and chirps 113, to processor 126 for processing.

Processor 126 performs a first FFT operation on the radar data to produce a first set of range data that corresponds to chirps 111 and 113. Processor 126 may perform the first FFT operation using a resolution. In an example, this may include performing a non-zero padded range FFT operation. In some embodiments a zero-padded FFT may be performed for higher resolution. The first set of range data may include a number of data points with respect to range and signal power. Processor 126 writes the first set of range data to buffer 127 of range processing circuitry 125.

Next, processor 126 performs a frequency shift on the radar data to produce a frequency-shifted set of range data. In various examples, processor 126 may shift the frequency of the first set of range data by half of a range-bin. However, in other examples, processor 126 may perform a frequency shift of a different range-bin value.

Processor 126 performs a second FFT operation on the frequency-shifted set of range data to produce a second set of range data. In this example, processor 126 performs the second FFT operation. The resolutions of the grids with respect to the first FFT operation and the second FFT operation may be the same. However, processor 126 may use different resolution grids for each or both of the FFT operations. Like the first FFT operation, processor 126 may produce the second set of range data that may include a number of data points with respect to range and signal power, however, the data points may be shifted with respect to range relative to the data points of the first set of range data. Processor 126 can write the second set of range data to buffer 127.

After performing the FFT operations, processor 126 reads both the first set and the second set of range data from buffer 127, collates portions of the sets of range data together to produce a third set of range data, and writes the third set of range data to buffer 127. In an example, processor 126 collates all of the data points of the first set of range data with a portion of the data points of the second set of range data. In another example, processor 126 collates a portion of the data points of the first set of range data with all of the data points of the second set of range data. In this way, the third set of range data includes fewer than all of the data points produced from the first and second FFT operations. Processor 126 may select the data points within either the first or second sets of range data to be collated together based on one or more thresholds, such as a range threshold. For example, processor 126 may refrain from collating data of the first or the second sets of range data that falls below the range threshold. In other words, if processor 126 does not collate some of either the first or second set of range data, processor 126 might not write such data in buffer 127. In effect, processing circuitry 12 may reduce memory capacity requirements of buffer 127 or of a memory of downstream circuitry 405 without reducing the efficacy of using the third set of range data with respect to detecting distances and positions of an object relative to transceiver circuitry 102.

Downstream circuitry 405 may obtain the third set of range data from buffer 127 or directly from processor 126. Downstream circuitry 405 may be representative of a digital signal processor (DSP), a component of thereof, or another system or subsystem capable of using the third set of range data to detect proximity of one or more objects relative to transceiver circuitry 102, among other functions.

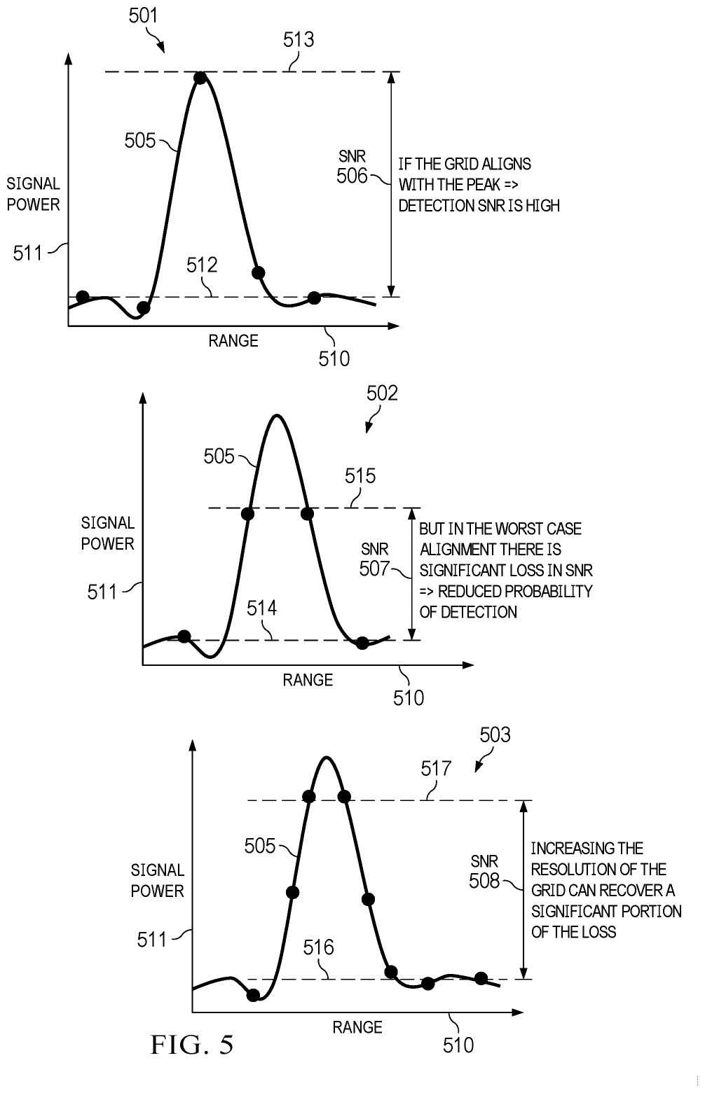

FIG. 5 illustrates the effect of FFT resolution on the SNR at which the target is detected and which may impact the probability of target detection. FIG. 5 includes waveforms 501, 502, and 503, which each include range profile 505 with respect to range 510 and signal power 511 and a respective detection SNR.

In FIG. 5, graphical representations are provided that demonstrate a portion of a waveform of range profile 505. A sampling of the range profile on a discrete grid is referred to as range data (represented by solid dots in waveforms 501, 502, and 503). Range data can be produced by performing one or more range FFT operations on radar data. For example, a transceiver (e.g., transceiver circuitry 102 of FIG. 1) can obtain the radar data by transmitting chirps towards one or more objects, receiving return chirps reflected off the one or more objects, and converting the chirps from analog signals to digital signals. A circuit or processor (e.g., range processing circuitry 125 of FIG. 1) can then be configured to perform one or more range FFT operations on the digital signals to produce range data (denoted by solid circles in the waveform of range profile 505). Peaks in the waveform of the range profile 505 may correspond to objects in front of the transceiver.

A digital signal processor (DSP) (e.g., downstream circuitry 405) may be configured to detect objects from the range data using a detection Algorithm. A detection algorithm detects objects by comparing the signal power of each data point in the range data with respect to a noise floor (noise floors 512, 514, and 516) and a noise ceiling (noise ceilings 513, 515, and 517). The noise floor may refer to a first, lower power threshold, while the noise ceiling may refer to a second, upper power threshold greater than the lower power threshold. An object whose corresponding data points have a higher reflected signal power (and correspondingly a higher SNR) than the noise floor has a higher chance of detection.

In waveform 501, one of the data points in the range data coincides with the peak corresponding to the object, with SNR 506 representing the associated SNR. In waveform 502, range profile 505 is offset with respect to the sampling grid of the range-FFT such that the data point closest to the peak has an SNR 507 which is lower than the SNR 506 of waveform 501. Thus, while the range data in both waveforms 501 and 502 is generated by range FFTs with the same resolution, any offset in the object peak (with respect to the sampling grid) can affect the detection SNR.

Waveform 503 depicts the same range profile 505 as waveforms 501 and 502, but with the range data created using a zero-padded range-FFT with twice the resolution. Thus, the range profile 505 in waveform 503 is sampled on a grid with twice the resolution compared to the depictions in waveforms 501 and 502. Consequently, in waveform 503, the data point closest to the object peak has a higher SNR (SNR 508) compared to the SNR in waveform 502 (SNR 507). A range-FFT with a higher resolution (i.e. sampling the range profile on a finer grid) limits the SNR loss due to the object peak not aligning with the sampling grid. This is especially relevant for distant objects whose signal power (and thus SNR) typically is low to begin with.

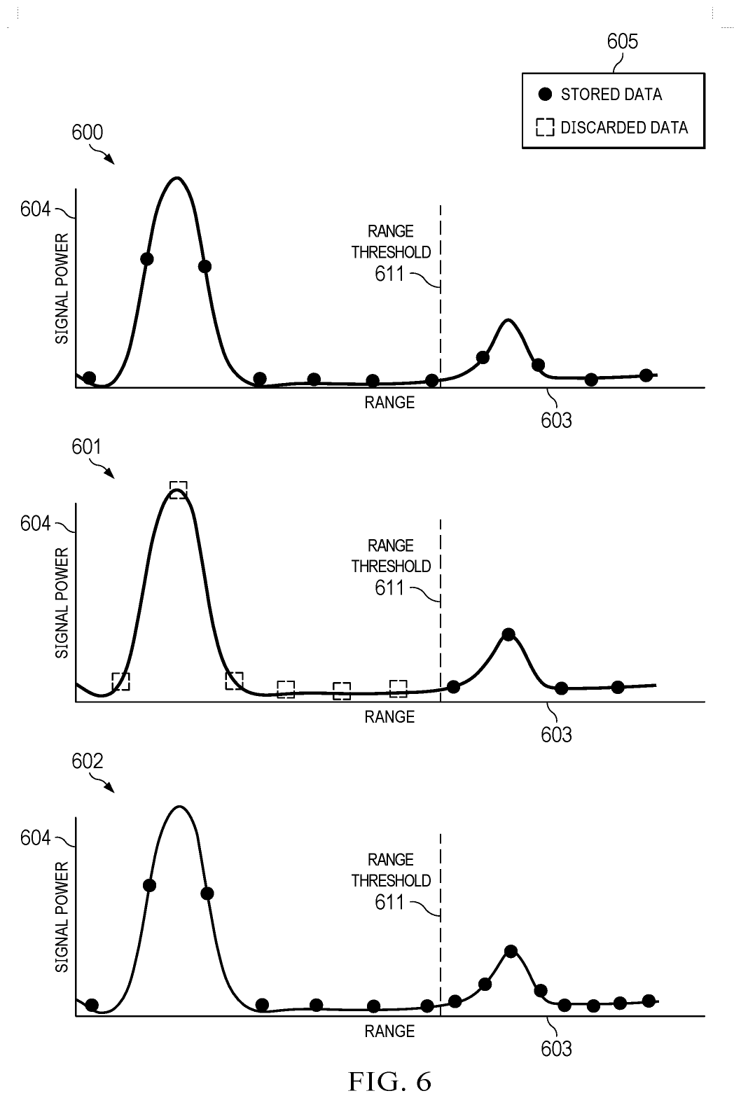

FIG. 6 illustrates graphical representations showing range data and an associated threshold in an implementation. FIG. 6 shows graphical representations 600, 601, and 602, which each show a waveform including range data with respect to range 603 and signal power 604. Each graphical representation includes range threshold 611, against which the range data may be compared to identify data to store or discard (denoted by icons in legend 605). Although FIG. 6 depict data from two FFT operations, a radar system may be configurable to perform three or more FFT operations and to collate data from the three or more FFT operations into an output data set.

Graphical representation 600 shows a first set of range data. The range data may include a number of range bins, which may be produced by performing a range FFT operation on radar data captured by a transceiver (e.g., transceiver circuitry 102 of FIG. 1). In an example implementation, range processing circuitry (e.g., range processing circuitry 125 of FIG. 1) may perform the FFT operation using a resolution, resulting in a number of data points in the first set of range data. The range FFT operation may produce a number of data points above and below the range threshold 611 (e.g., inside and beyond the range threshold 611). The data points are denoted by bolded circles as indicated by legend 605. All these data points may be stored.

Graphical representation 601 shows a second set of range data. The second set of range data may include the same number of data points as the first set of range data. However, in this example implementation, the range processing circuitry may perform a frequency shift on the radar data prior to performing a second FFT operation on the radar data. The range processing circuitry may perform the frequency shift on the radar data by half of a range-bin, for example. This frequency shift is shown in graphical representation 601 as the four data points beyond the range threshold 611 being shifted relative to the data points in graphical representation 600. For example, there is a data point near the top of the smaller peak beyond the range threshold 611 in graphical representation 601, while the data points in graphical representation 600 are not near the top of this smaller peak. Then, the range processing circuitry may perform the second FFT operation on the frequency-shifted radar data to produce the second set of range data. The second FFT operation may have the same resolution as the first FFT operation. The range processing circuitry may store a portion of the data points produced by the second FFT operation and discard the other data points. For example, the range processing circuitry may store a portion of the data points meeting or exceeding range threshold 611 and may discard all of the data points below range threshold 611. Range threshold 611 may correspond to a distance. Data points beyond range threshold 611 may correlate to objects farther away from a transceiver, and thus, may be more difficult to detect relative to objects closer to the transceiver that may be identified using data points below range threshold 611. The stored data points are denoted by bolded circles on graphical representation 601 and discarded data, or data that the range processing circuitry does not store in a memory, are denoted by dashed circles on graphical representation 601.

Graphical representation 602 shows a third set of range data. The third set of range data may include a combination of the stored data from the first set of range data and the second set of range data. More particularly, the range processing circuitry can collate (e.g., combine) the stored data points produced by the first FFT operation and the stored data points produced by the second FFT operation. In other words, the third set of range data includes data points from one FFT operation that fall below range threshold 611 and data points from two or more FFT operations meeting or exceeding range threshold 611. For example, the density of data points beyond range threshold 611 in graphical representation 602 is double the density of data points beyond range threshold 611 in graphical representation 600. In this way, additional data points beyond range threshold 611 may be captured and processed, which may increase the probability and accuracy of detecting objects at distances beyond range threshold 611, while data points below range threshold 611 may be discarded, which may reduce memory capacity requirements of a system.

In various example embodiments, range threshold 611 may be selected based on the resolution of the grid used in the FFT operations and based on a desired maximum detection range for a system. Range threshold 611 may be pre-programmed into a radar system before the radar system is put into operation (e.g., in the factory). Additionally or alternatively, range threshold 611 may be calibrated or changed while the radar system is in the field, for example through a software/firmware update.

By way of example, a radar system onboard an automobile may be designed with a desired maximum detection range of 160 meters. The maximum detection range (dₘₐₓ) may be defined using the following equation where Pt is the transmitted power, G_{TX} is the gain of the transmitting antenna, G_{RX} is the gain of the receiving antenna, λ is the wavelength corresponding to the center frequency of the radio frequency (RF) transmission (e.g., 77 GHz equates to 4 cm), Tₘₑₐₛ is the total active time of a frame (i.e., exposure time), k is Boltzmann's constant, T is the temperature in Kelvin, σ is the radar cross section of the target or object, F is the noise figure of the receiver, and α is the loss due to performing the FFT operation on a grid:

$${d}_{max} = {( \frac{σ {P}_{t} {G}_{T X} {G}_{R X} {λ}^{2} {T}_{m e a s}}{{( 4 π )}^{3} α S N {R}_{min} k T F} )}^{\frac{1}{4}}$$

Here α (worst case loss due to FFT resolution) depends on the windowing used during the FFT operation. The table below shows the loss under the assumption of the Hanning window. The first row shows the worst case loss due to a non-zero padded FFT—this loss captures the loss in Signal power due to the object peak not aligning with the FFT grid. As the FFT resolution improves (row 2 and 3 of the table), this loss correspondingly decreases.

TABLE 1

| Zero Padding | | Typical Memory |
|---|---|---|
| (grid resolution) | SNR loss | increase |
| 1x (Baseline) | 1.43 dB | N/A |
| 2x | 0.35 dB | 2x |
| 4x | 0.08 dB | 4x |

In this example, the maximum achievable detection range may be a range of 150 meters when 1× zero padding on a range FFT operation. When using 2× zero padding on the range FFT operation, a gain of 1.08 dB (from Table 1:1.43 dB-0.35 dB) may be realized, which may increase the range by 7%, and thus, increase the achievable detection range from 150 meters to 160 meters. However, this increase in resolution and gain increases memory capacity requirements by two times in existing solutions given the resolution is increased by two times. To achieve the range detection improvement without significantly increasing memory capacity requirements, range threshold 611 may be set to 150 meters. Thus, all bins of the range FFT operation corresponding to a distance of less than 150 meters may be stored with a coarse grid (i.e., 1× zero padding). All bins of the range FFT operation corresponding to a distance greater than or equal to 150 meters may be stored on a fine grid (2× zero padding). Since only range data between 150 meters (i.e., range threshold 611) and 160 meters (i.e., the desired detection range) is stored on the finer grid, the increase in memory capacity requirements may be reduced (˜7% increase).

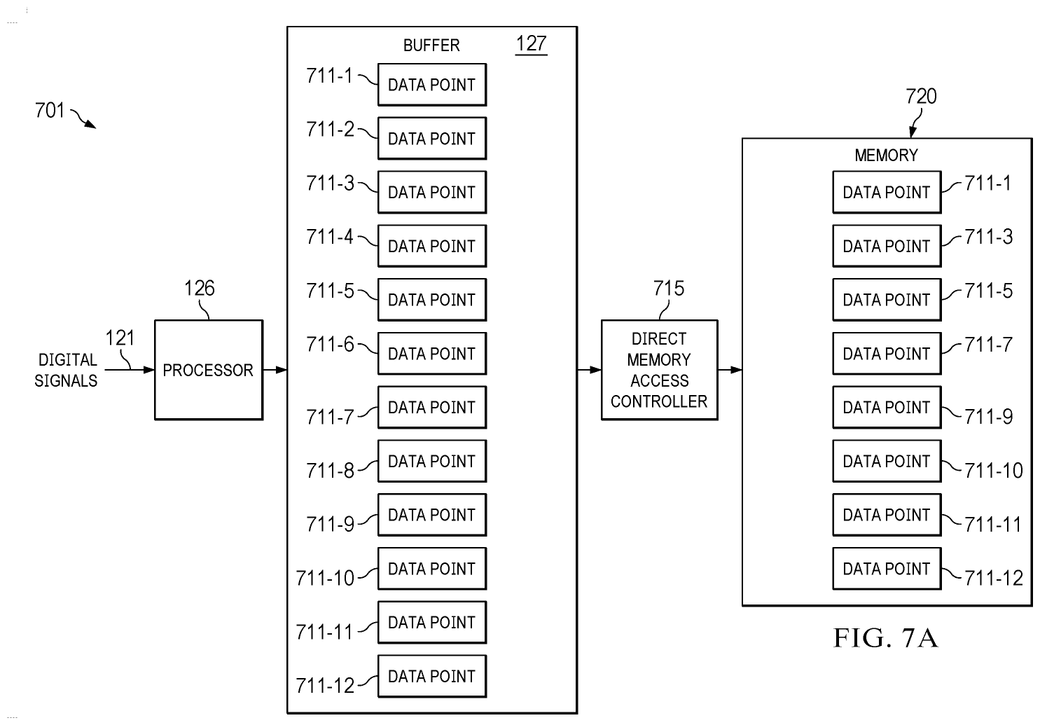

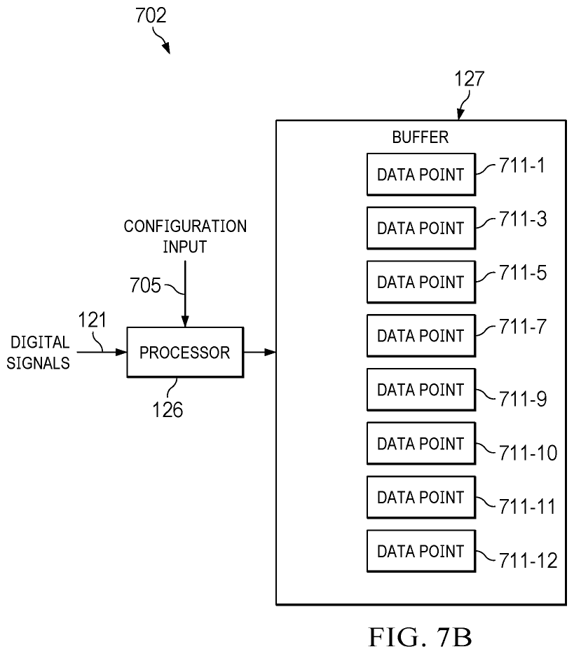

FIGS. 7A and 7B illustrate example block diagrams related to processing range data in an implementation. FIG. 7A shows block diagram 701, and FIG. 7B shows block diagram 702, each of which reference elements of FIG. 1. Block diagram 701 includes processor 126, buffer 127, direct memory access (DMA) controller 715, and memory 720. Block diagram 702 includes processor 126 and buffer 127.

Referring first to block diagram 701 of FIG. 7A, processor 126 is configured to obtain digital signals 121 from a transceiver (e.g., transceiver circuitry 102). Digital signals 121 may include radar data transmitted from an antenna towards one or more objects and received by an antenna following reflection of the transmissions off the one or more objects. Processor 126 may be configured to perform one or more range FFT operations on digital signals 121 to produce data points 711-1, 711-2, 711-3, 711-4, 711-5, 711-6, 711-7, 711-8, 711-9, 711-10, 711-11, and 711-12 (collectively referred to as data points 711). Following the FFT operation(s), processor 126 stores data points 711 in buffer 127.

DMA controller 715 may be representative of a control device of a system capable of obtaining data from one or more memory locations and writing the data to one or more different memory locations, such as memory 720. Memory 720 may be representative of a computer-readable, non-transitory storage media capable of storing data points 711 among other data and/or instructions. In various embodiments, DMA controller 715 and memory 720 may be part of a digital signal processor or other system (e.g., downstream circuitry 405) configured to detect objects and relative positions using data points 711.

In some embodiments, DMA controller 715 is configured to obtain a portion of data points 711 from buffer 127 and write the portion of data points 711 to memory 720. In other words, DMA controller 715 may be configured to prune data points 711 and select a subset of data points 711 for storage in memory 720. By way of example, DMA controller 715 may obtain data points 711-1, 711-3, 711-5, 711-7, 711-9, 711-10, 711-11, and 711-12 from buffer 127 and write these data points to memory 720. Data points 711-9 through 711-12 may correspond to data points of range data beyond a range threshold (e.g., range threshold 611 of FIG. 6), while data points 711-1 through 711-8 may correspond to data points of range data below the range threshold. Accordingly, DMA controller 715 may store some of the data points below the range threshold and all of the data points above the range threshold. In this way of storing data points 711, capacity requirements of memory 720 may be reduced.

Referring next to block diagram 702 of FIG. 7B, processor 126 is configured to obtain digital signals 121 from the transceiver and configuration input 705 from a digital signal processor or other system. Configuration input 705 may include an instruction that, when read and executed by processor 126, directs processor 126 to store portions of data points 711 in buffer 127 following one or more FFT operations. For example, configuration input 705 may indicate a range threshold as well as an instruction to store a number of data points 711 below the range threshold and a number of data points 711 above the range threshold. As a result, processor 126 can perform one or more FFT operations on digital signals 121 and perform a pruning operation in-situ (i.e., determine which of data points 711 to store). In an embodiment, processor 126 may determine that data points 711-1, 711-3, 711-5, 711-7, 711-9, 711-10, 711-11, and 711-12 may be stored while processor 126 performs the FFT operation on digital signals 121. Accordingly, processor 126 can store data points 711-1, 711-3, 711-5, 711-7, 711-9, 711-10, 711-11, and 711-12 in buffer 127 while performing the FFT operation and refrain from storing, or discarding, other data points 711, such as data points 711-2, 711-4, 711-6, and 711-8 during the FFT operation. In this way, processor 126 may conserve memory capacity of buffer 127 as processor 126 might not store all range bins in buffer 127 following an FFT operation, but rather, processor 126 may select range bins to be stored in buffer 127 on-the-fly based on a range threshold.

While some examples provided herein are described in the context of radar, radio frequency, range detection, range processing, and/or digital processing systems, transceiver circuitry, hardware accelerator circuitry, electrical components and environments thereof, the systems and methods described herein are not limited to such embodiments and may apply to a variety of other processes, systems, applications, devices, and the like. Aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. A system, comprising:
transceiver circuitry; and
processing circuitry coupled to the transceiver circuitry;
wherein the transceiver circuitry is configured to:
receive signals reflected off an object; and
generate radar data based on the received signals;
wherein the processing circuitry is configured to:
perform a first Fast-Fourier Transform (FFT) operation on the radar data to produce a first set of range data;
perform a frequency shift on the radar data;
perform a second FFT operation on the frequency shifted radar data to produce a second set of range data; and
produce a third set of range data by at least:
collating the first set of range data and a portion of the second set of range data; or
collating a portion of the first set of range data and the second set of range data.

2. The system of claim 1, wherein the first FFT operation comprises a first resolution, and wherein the second FFT operation comprises a second resolution.

3. The system of claim 2, wherein the first and second resolutions are the same, and wherein the first and second resolutions are based on a desired detection range.

4. The system of claim 1, wherein the frequency shift includes a shift of the radar data by half of a range-bin.

5. The system of claim 1, wherein the portion of the first set of range data comprises data of the first set of range data above a range threshold, and wherein the portion of the second set of range data comprises data of the second set of range data above the range threshold.

6. The system of claim 5, wherein to collate the first set of range data and the portion of the second set of range data, the processing circuitry is configured to refrain from using the data of the second set of range data below the range threshold in the third set of range data, and wherein to collate the portion of the first set of range data and the second set of range data, the processing circuitry is configured to refrain from using the data of the first set of range data below the range threshold in the third set of range data.

7. The system of claim 1, wherein the processing circuitry is further configured to identify a distance between the transceiver circuitry and the object based on the third set of range data.

8. A method, comprising:
obtaining radar data generated by radar transceiver circuitry;
performing a first Fast-Fourier Transform (FFT) operation on the radar data to produce a first set of range data;
performing a frequency shift on the radar data;
performing a second FFT operation on the frequency shifted radar data to produce a second set of range data; and
producing a third set of range data by at least:
collating the first set of range data and a portion of the second set of range data; or
collating a portion of the first set of range data and the second set of range data.

9. The method of claim 8, wherein the first FFT operation comprises a first resolution, and wherein the second FFT operation comprises a second resolution.

10. The method of claim 9,
wherein the first resolution and the second resolution are the same, and
wherein the first and second resolutions are based on a desired detection range.

11. The method of claim 8, wherein the frequency shift includes a shift of the radar data by half of a range-bin.

12. The method of claim 8, wherein the portion of the first set of range data comprises data of the first set of range data above a range threshold, and wherein the portion of the second set of range data comprises data of the second set of range data above the range threshold.

13. The method of claim 12, wherein collating the first set of range data and the portion of the second set of range data comprises refraining from using the data of the second set of range data below the range threshold in the third set of range data, and wherein collating the portion of the first set of range data and the second set of range data comprises refraining from using the data of the first set of range data below the range threshold in the third set of range data.

14. The method of claim 8, further comprising identifying a distance between the radar transceiver circuitry and an object based on the third set of range data.

15. A radar circuit, comprising:
a buffer; and
processing circuitry coupled to the buffer and configured to:
obtain radar data stored in the buffer;
perform a first Fast-Fourier Transform (FFT) operation on the radar data to produce a first set of range data;
perform a frequency shift on the radar data;
perform a second FFT operation on the frequency shifted radar data to produce a second set of range data; and
producing a third set of range data for storage in the buffer by at least:
collating the first set of range data and a portion of the second set of range data; or
collating a portion of the first set of range data and the second set of range data.

16. The radar circuit of claim 15, wherein the first FFT operation comprises a first resolution, and wherein the second FFT operation comprises a second resolution.

17. The radar circuit of claim 16, wherein the first and second resolutions are the same, and wherein the first and second resolutions are based on a desired detection range.

18. The radar circuit of claim 15, wherein the frequency shift includes a shift of the radar data by half of a range-bin.

19. The radar circuit of claim 15, wherein the portion of the first set of range data comprises data of the first set of range data above a range threshold, and wherein the portion of the second set of range data comprises data of the second set of range data above the range threshold.

20. The radar circuit of claim 19, wherein to collate the first set of range data and the portion of the second set of range data, the processing circuitry is configured to refrain from storing the data of the second set of range data below the range threshold in the buffer, and wherein to collate the portion of the first set of range data and the second set of range data, the processing circuitry is configured to refrain from storing the data of the first set of range data below the range threshold in the buffer.
